(19) United States
(12) Patent Application Publication
(10) Pub. No.: US 2008/0002850 A1
(43) Pub. Date: Jan. 3, 2008

(54) Speaker and manufacturing method

(75) Inventors: Kazuaki Watanabe, Yamagata (JP); Masanori Ito, Yamagata (JP); Shoichi Toyoda, Yamagata (JP)

Correspondence Address: ARENT FOX LLP, 1050 CONNECTICUT AVENUE, N.W., SUITE 400, WASHINGTON, DC, 20036, US

(73) Assignees: PIONEER CORPORATION; TOHOKU PIONEER CORPORATION

(21) Appl. No.: 11/812,235

(22) Filed: Jun. 15, 2007

(30) Foreign Application Priority Data
Jun. 16, 2006 (JP) 2006-167048

(51) Int. Cl. H04R 9/06; H04R 1/00

(52) U.S. Cl. 381/412

(57) ABSTRACT

Designing of a magnetic circuit without constraints of a shape of a diaphragm offers an enhancement in the degree of design freedom of a speaker. A diaphragm has a dome and an edge formed integrally with the dome. A coupling supporter is fixed to a boundary portion between the dome and the edge of the diaphragm and extends either inward or outward from the boundary portion in a radial direction of the diaphragm. A voice coil is fixed to a peripheral side of the coupling supporter. A magnetic circuit has a magnetic gap housing the voice coil.

### BACKGROUND OF THE INVENTION

This invention relates to a speaker and a method for manufacturing the speaker.

The present application claims priority from Japanese Application No. 2006-167048, the disclosure of which is incorporated herein by reference.

A speaker comprises a voice coil disposed in a magnetic gap and a diaphragm attached at its outer peripheral edge to the speaker frame. An audio signal is applied to the voice coil to cause it to vibrate. This vibration of the voice coil travels to the diaphragm, and thus the speaker produces sound. There are a variety of types of speaker diaphragm. A speaker having a dome diaphragm with approximately the same diameter as the speaker diameter is widely available as a compact speaker or an ultra-compact speaker. Such a speaker is disclosed in Japanese Unexamined Patent Publication No. 2003-259486, for example.

FIG. 1 is a sectional view illustrating the structure of a speaker having a conventional dome diaphragm. A diaphragm a has an outer annular edge a1 of hemispherical cross-section and a central convex dome a2. The outer portion of the edge a1 is attached to the inner edge of a framed. A boundary portion a3 is provided between the dome a2 and the edge a1. A voice coil b is coupled or bonded to the boundary portion a3 and is suspended so as to be accommodated in a magnetic gap c1 formed in a magnetic circuit c.

The coupling of the voice coil b to the boundary portion a3 between the dome a2 and the edge a1 has the purpose of transmitting vibrations from the voice coil b to the outer end of the dome 2 or the inner portion of the edge a1 in order for the entire dome a2 or the entire edge a1 to effectively function as a vibrating diaphragm.

For a speaker having such a conventional dome diaphragm, first, the shape of the diaphragm constituted of the edge a1 and the dome a2 is determined, then the voice coil b is coupled to the boundary portion a3. That is, the diameter of the voice coil b depends on the shape of the diaphragm. In turn, the shape of the magnetic circuit c is determined in accordance with the coupling position and the diameter of the voice coil b. As a result, the design of the speaker including the magnetic circuit is subject to the constraints of the shape of the diaphragm.

However, the speaker having the conventional dome diaphragm has the problem of an inevitable reduction in the degree of design freedom of the speaker, which arises, for example, when the magnetic circuit is required to be designed independently of the shape of the diaphragm, and conversely, when the shape of the diaphragm is required to be designed independently of the size of the magnetic circuit, such as when a reduction in the diameter of the magnetic circuit is required for a reduction in cost and weight of the entire speaker but the diaphragm has a large dome, or otherwise when an increase in the diameter of the magnetic circuit is required for an enhancement in the speaker performance but the diaphragm has a small dome.

Another problem arising is the impossibility of using an existing diaphragm or an existing magnetic circuit to provide a speaker with various types of performance. This is because the shape of the diaphragm imposes constraints upon the form of the magnetic circuit when an existing diaphragm is intended to be combined with a magnetic circuit offering various types of performance or when an existing magnetic circuit is intended to be combined with a diaphragm of any desired shape.

Also, a speaker having a conventional dome diaphragm necessarily has a total thickness that includes the thickness H which is the sum of the thickness H1 of the diaphragm a and the thickness H2 of the voice coil b (i.e., H=H1+H2), as shown in FIG. 1. This thickness H is the factor responsible for the limitations in achieving a reduction in the thickness of the speaker.

### SUMMARY OF THE INVENTION

The present invention has been made to overcome the foregoing problems. Accordingly, it is an object of the present invention to make possible the design of a magnetic circuit without constraints of a shape of a diaphragm for an enhancement in the degree of design freedom of a speaker, and make possible the use of an existing diaphragm or an exiting magnetic circuit to provide a speaker offering various types of performance, and equally make possible a reduction in the thickness of a speaker without constraints of the thickness of a diaphragm and the thickness of a voice coil.

To attain this object, an aspect of the present invention provides a speaker basically comprising: a diaphragm having a dome formed in an outwardly convex shape and in its central portion and an edge formed around and integrally with the dome; a coupling supporter fixed to a boundary portion of the diaphragm provided between the dome and the edge, and extending either inward or outward from the boundary portion in a radial direction of the diaphragm; a voice coil fixed to a peripheral side of the coupling supporter; and a magnetic circuit having a magnetic gap housing the voice coil.

Another aspect of the present invention provides a method for manufacturing a speaker comprising: a diaphragm having a dome formed in an outwardly convex shape and in its central portion and an edge formed around and integrally with the dome; a coupling supporter fixed to a boundary portion of the diaphragm provided between the dome and the edge and extending either inward or outward from the boundary portion in a radial direction of the diaphragm; a voice coil fixed to a peripheral side of the coupling supporter; and a magnetic circuit having a magnetic gap housing the voice coil. The method comprises the steps of: attaching a centering jig having a positioning groove corresponding to the magnetic gap to a speaker frame; inserting the voice coil in place in the positioning groove; fixing the coupling supporter to the voice coil; joining the boundary portion of the diaphragm and the coupling supporter together while an outer periphery of the diaphragm is attached to an inner periphery of the speaker frame; removing the centering jig from the speaker frame; and attaching the magnetic circuit to the speaker frame.

### BRIEF DESCRIPTION OF THE DRAWINGS

These and other objects and features of the present invention will become more apparent from the following detailed description with reference to the accompanying drawings.

FIG. 1 is a cross-sectional view illustrating part of a conventional speaker.

FIG. 2 is a cross-sectional view illustrating part of a speaker according to a first embodiment of the present invention.

FIG. 3 is a cross-sectional view illustrating part of a speaker according to a second embodiment of the present invention.

FIG. 4 is a cross-sectional view illustrating part of a speaker according to a third embodiment of the present invention.

FIG. 5 is a cross-sectional view illustrating part of a speaker according to a fourth embodiment of the present invention.

FIG. 6 is a cross-sectional view illustrating part of a speaker according to the fourth embodiment of the present invention.

FIG. 7A and FIG. 7B are diagrams for illustrating the steps of manufacturing a speaker in a fifth embodiment according to the present invention.

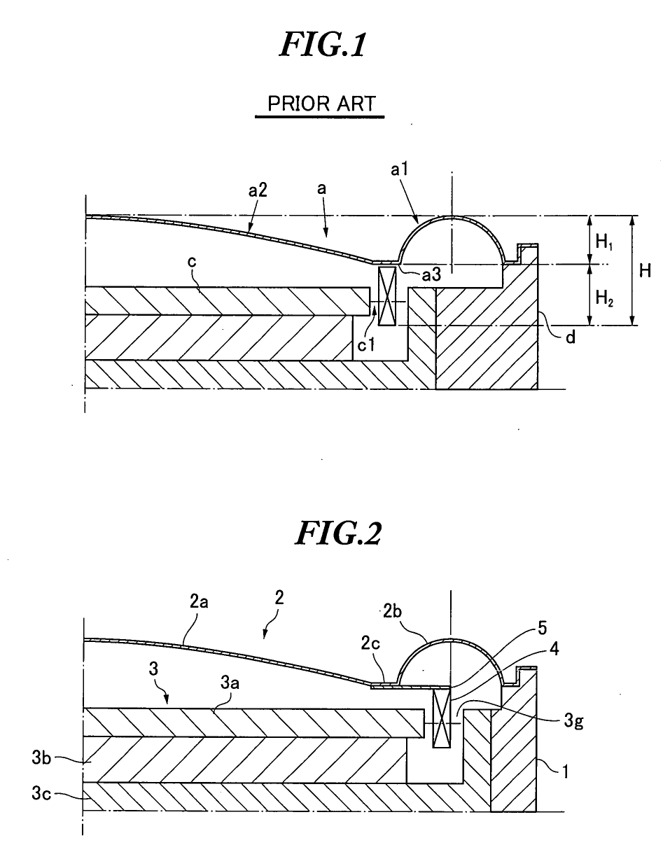

### DETAILED DESCRIPTION OF THE PREFERRED EMBODIMENTS

Embodiments of the present invention will be described below with reference to the accompanying drawings. FIG. 2 is a sectional view illustrating the structure of a speaker according to a first embodiment of the present invention, which comprises a diaphragm 2 coupled at its outer edge to the inner edge of an approximately cylindrically shaped frame 1, and a magnetic circuit 3 mounted in the frame 1. A voice coil 4 is disposed in a magnetic gap 3g in the magnetic circuit 3. A coupling supporter 5 provides the coupling between the voice coil 4 and the diaphragm 2.

The diaphragm 2 is made up of an outwardly convex dome 2a at its center, an outwardly convex cross-section edge 2b formed integrally with the dome 2a on the outer periphery of the dome 2a, and an approximately flat boundary portion 2c between the dome 2a and the edge 2b.

The coupling supporter 5 is formed of a ring-shaped disk member having an opening at its center and coupled at one peripheral side (the inner peripheral side in FIG. 2) to the boundary portion 2c between the dome 2a and the edge 2b of the diaphragm 2 so as to extend outward from the boundary portion 2c in the radial direction of the diaphragm 2.

The voice coil 4 is attached to the other peripheral side (the outer peripheral side in FIG. 2, that is, the distal peripheral side) of the coupling supporter 5, and housed in the magnetic gap 3g of the magnetic circuit 3. The magnetic circuit 3 used in this embodiment is of an inner magnet type and comprises a top plate 3a, a magnet 3b and a yoke 3c. However, the magnetic circuit 3 is not limited to this, and may be of an outer magnet type having a magnet disposed outside the magnetic gap 3g.

In this speaker, in response to the reception of an audio signal at an input terminal (not shown) of the voice coil 4, the voice coil 4 vibrates vertically within the magnetic gap 3g in FIG. 2. This vibration is transferred to the diaphragm 2 through the coupling supporter 5, thus producing sound.

In the first embodiment, since the diaphragm 2 and the voice coil 4 are coupled though the coupling supporter 5, the determination of the radial-direction width (i.e., the amount of extension from the position attached to the diaphragm) of the coupling supporter 5 as required makes it possible to design the position and the diameter of the voice coil 4 regardless of the shape of the diaphragm 2 (e.g., the size relationship between the dome 2a and edge 2b). Conversely, the shape of the diaphragm 2 can be designed in accordance with desired audio characteristics regardless of a size of the magnetic circuit 3 and the position and the diameter of the voice coil 4 dependent on the size of the magnetic circuit 3.

In the example of the first embodiment as shown in FIG. 2, an increase in the size of the magnetic circuit 3 can be achieved regardless of the shape of the diaphragm 2, thus improving the output performance of the speaker.

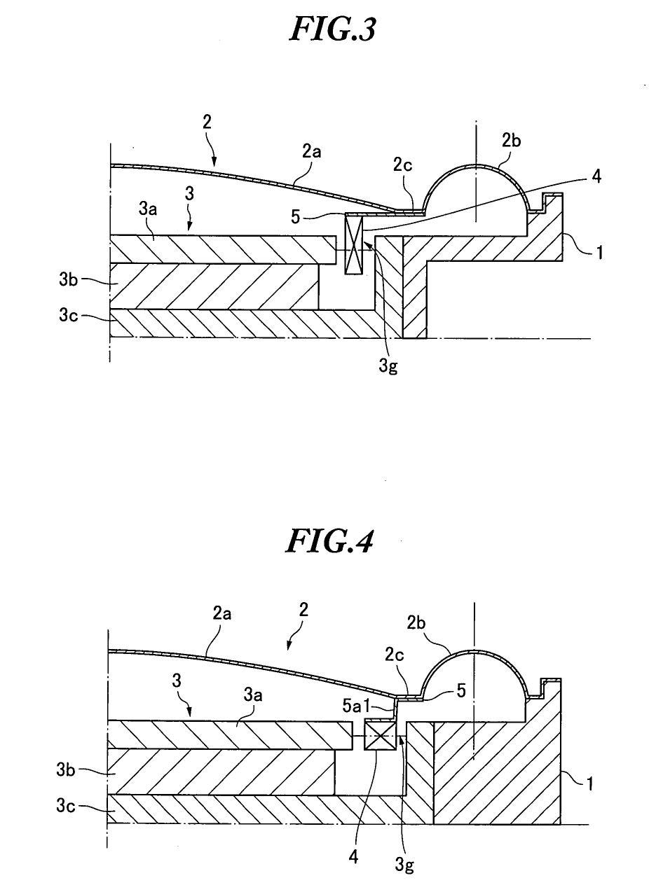

FIG. 3 is a sectional view illustrating a speaker according to a second embodiment of the present invention, in which the same components as those in the first embodiment in FIG. 2 are designated by the same reference numerals and a partially repetition of the description is omitted. In the second embodiment, the coupling supporter 5 extends inward from the boundary portion 2c of the diaphragm 2 in the radial direction of the diaphragm 2. The voice coil 4 is attached to the distal peripheral side of the coupling supporter 5.

In the second embodiment, since the diaphragm 2 and the voice coil 4 are also coupled though the coupling supporter 5, the determination of the radial-direction width of the coupling supporter 5 as required makes it possible to design the position and the diameter of the voice coil 4 regardless of the shape of the diaphragm 2 (e.g., the size relationship between the dome 2a and edge 2b). Conversely, the shape of the diaphragm 2 can be designed in accordance with desired audio characteristics regardless of the size of the magnetic circuit 3 and the position and the diameter of the voice coil 4 dependent on the size of the magnetic circuit 3.

In the example of the second embodiment as shown in FIG. 3, the magnet size of the magnetic circuit 3 can be reduced with respect to the shape of the diaphragm 2. As a result, the manufacturing costs are reduced, and additionally, an extra space can be provided in back of the speaker so as to ensure a mounting space for the speaker without a reduction in size of the diaphragm 2.

According to the first and second embodiments shown in FIGS. 2 and 3, it is possible to enhance the degree of design freedom when an existing diaphragm or an existing magnetic circuit is used in the design of the speaker. In a conventional speaker, since the voice coil is coupled directly to the boundary portion of the diaphragm, once the shapes and the sizes of the dome and the edge are determined based on the shape of the diaphragm, the magnetic gap in the magnetic circuit is required to be positioned in conformance with this determination. As a result, it is impossible to use an existing diaphragm or a magnetic circuit to design a speaker with a high degree of freedom.

According to the first and second embodiments, for the designing of a new speaker using an existing diaphragm 2, the size of the magnetic circuit 3 can be determined without constraints of the shape and the size of the diaphragm 2. Alternatively, in the case of use of an existing magnetic circuit 3, the dimensions of the diaphragm 2 (the dome diameter of the dome 2a, the diameter of the hemispherical shape of the edge 2b) can be determined without constraints of the shape of the magnetic circuit 3.

According to the first and second embodiments, when the size of the magnetic circuit 3 is already fixed, the coupling supporter 5 extends inward from the boundary portion 2c toward the center of the diaphragm 2 so that the coupling position between the boundary portion 2c and the coupling supporter 5 is located outside the magnetic circuit 3. Thereby, the size of the hemispherical shape of the edge 2b of the diaphragm 2 can be reduced so as to increase its stiffness and the effective vibration area of the dome 2a can be increased, leading to the achievement of an improvement in maximum power input and high speaker sensitivity.

By contraries, when the size of the magnetic circuit 3 is already fixed, the coupling supporter 5 extends outward from the boundary portion 2c toward the periphery of the diaphragm 2 so that the coupling position between the boundary portion 2c and the coupling supporter 5 is located inside the magnetic circuit 3. Thereby, the size of the hemispherical shape of the edge 2b of the diaphragm 2 can be increased so as to increase compliance, leading to the achievement of a speaker allowing for reproduction of broadband sound.

FIG. 4 is a sectional view illustrating a speaker according to a third embodiment of the present invention, in which the same components as those in the foregoing embodiments are designated by the same reference numerals and a partially repetition of the description is omitted. In the third embodiment, the coupling supporter 5 has a bending portion 5a1 bent in the vibration direction of the voice coil 4.

The coupling supporter 5 in the third embodiment is coupled at the outer peripheral side to the boundary portion 2c in FIG. 4, and extends toward the center of the diaphragm 2. The bending portion 5a1 is formed in the middle area of the coupling supporter 5. The voice coil 4 is attached to the inner peripheral side (i.e. the distal peripheral side) of the coupling supporter 5. In the example shown in FIG. 4, the coupling supporter 5 extends toward the center of the diaphragm 2 so that a smaller-size magnetic circuit 3 can be operated in association with the diaphragm 2 larger than it. By contraries, the coupling supporter 5 may extends toward the periphery of the diaphragm 2 so that a larger-size magnetic circuit 3 can be operated in association with the diaphragm 2 smaller than it.

In the third embodiment, in addition to the foregoing advantages, the bending portion 5a1 of the coupling supporter 5 extending in the vibration direction prevents the coupling supporter 5 from being warped or twisted by the vibration of the voice coil 4 and allows the coupling supporter 5 to function as a reinforcement material for the voice coil 4. As a result, the linearity of the vibration of the voice coil 4 is improvement and the vibration of the voice coil 4 linearly travels to the diaphragm 2.

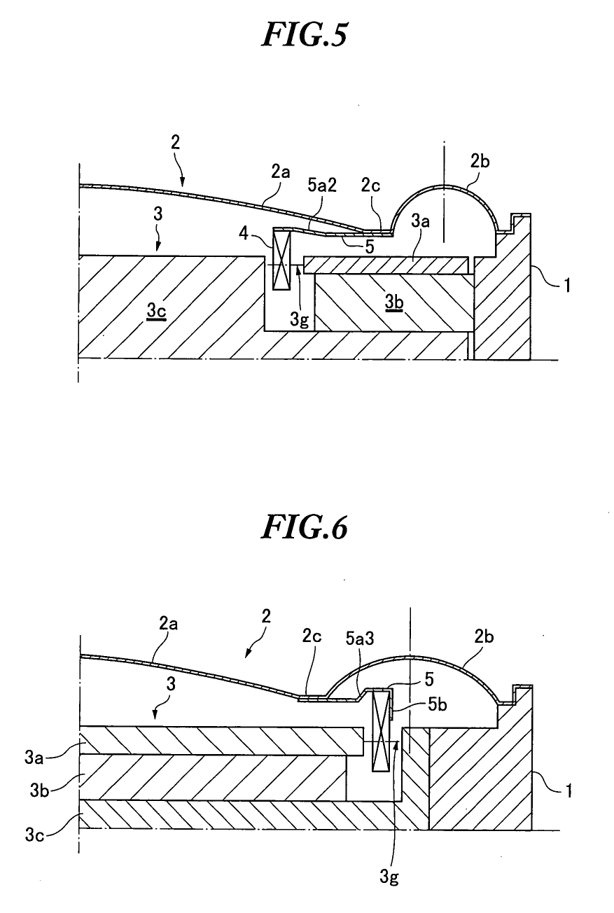

FIG. 5 and FIG. 6 are sectional views illustrating a speaker according to a fourth embodiment of the present invention, in which the same components as those in the foregoing embodiments are designated by the same reference numerals and a partially repetition of the description is omitted. In the fourth embodiment, the coupling supporter 5 has a bending portion 5a2, 5a3 that bends the coupling supporter 5 such that the distal peripheral side is located in the intra-dome space of the diaphragm 2.

In the example of the fourth embodiment shown in FIG. 5, the coupling supporter 5 is coupled at the outer end to the boundary portion 2c, and extends toward the center of the diaphragm 2. The bending portion 5a2 is formed in the middle area of the coupling supporter 5. The voice coil 4 is attached to the distal peripheral side of the coupling supporter 5. The magnetic circuit 3 is of an outer magnet type in which a magnet 3b is disposed outside of the voice coil 4.

In the example of the fourth embodiment shown in FIG. 6, the coupling supporter 5 is coupled at the inner end to the boundary portion 2c, and extends toward the periphery of the diaphragm 2. The bending portion 5a3 is formed in the middle area of the coupling supporter 5. The voice coil 4 is attached to the distal peripheral side of the coupling supporter 5. In addition, another bending portion 5b bends at and extends from the distal peripheral side along the voice coil 4 to function as a guide for the voice coil 4.

According to the fourth embodiment shown in FIGS. 5 and 6, in addition to the foregoing advantages, the spaces within the dome 2a and the edge 2b are effectively used to position the voice coil 4. In consequence, the thickness of the voice coil 4 can be incorporated into the thickness of the diaphragm 2, thus making possible a reduction in thickness of the entire speaker. In addition, the structure of preventing the diaphragm 2 vibrating vertically in FIGS. 5 and 6 from causing interference with the other components can be achieved.

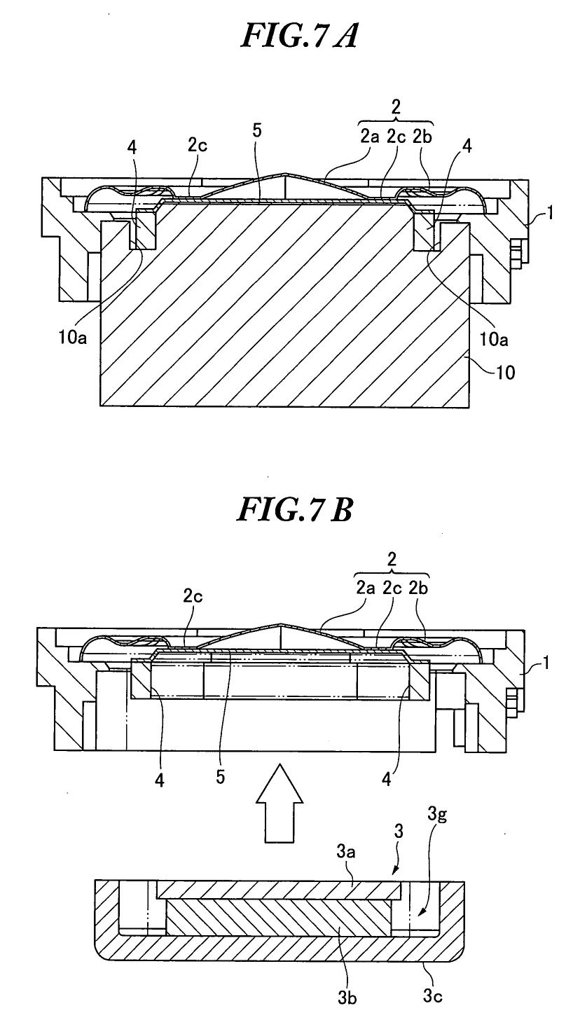

FIGS. 7A and 7B are diagrams illustrating the steps of manufacturing the speaker according to a fifth embodiment of the present invention. In the embodiment, a centering jig 10 having a positioning groove 10a corresponding to the magnetic gap 3g is attached to the frame 1. Then, the voice coil 4 is positioned in the positioned groove 10a, and then the coupling supporter 5 is coupled to the voice coil 4. Then, while the outer periphery of the diaphragm 2 is coupled to the inner periphery of the frame 1, the boundary portion 2c of the diaphragm 2 is aligned with and secured to the coupling supporter 5. Then, the centering jig 10 is removed from the frame 1, and then the magnetic circuit 3 is mounted in the frame 1.

Specifically, as illustrated in FIG. 7A, first, the centering jig 10 is inserted into and attached to the frame 1 from the bottom opening. Then, the voice coil 4 is placed in the positioning groove 10a of the centering jig 10, and then is joined to the distal peripheral side of the coupling supporter 5. Then, while the boundary portion 2c of the diaphragm 2 is aligned with and joined to the coupling supporter 5, the outer periphery of the diaphragm 2 is attached to the inner periphery of the frame 1. In this case, the diaphragm 2 has the dome 2a and the edge 2b as described above.

After the diaphragm 2 has been attached to the frame 1, the centering jig 10 is removed from the frame 1. Into the space created by this removal of the centering jig 10, the magnetic circuit 3 is fitted and attached to the frame 1. The magnetic circuit 3 comprises the top plate 3a, the magnet 3b and the yoke 3c as described earlier. The voice coil 4 is inserted into the magnetic gap 3g.

In the above-described manufacturing method, the diaphragm 2, the coupling supporter 5 and the voice coil 4, which are related to the embodiments of the present invention describing the foregoing structure, are positioned in place with their centers being reliably aligned with each other, and then are attached to the frame 1. In consequence, the positional adjustment between the magnetic circuit 3 and the diaphragm 2, the coupling supporter 5 or the voice coil 4 can be simplified.

In addition, a feature of the embodiments of the present invention is the integral formation of the dome 2a, the edge 2b and the boundary portion 2c of the diaphragm 2. When the dome 2a and the edge 2b are formed of separate members and joined together, the variations are apt to occur in the assembly process, leading to variations in diaphragm performance.

Further, for transmitting the vibration of the voice coil 4 to the diaphragm 2 with reliability, the coupling supporter 5 is preferably formed on a lightweight material of high strength. The bending portion of the coupling supporter 5 is preferably formed in an R shape to provide a sufficient strength.

According to the present invention, as described above, a magnetic circuit can be designed without constraints of the shape of the diaphragm, which in turn making it possible to increase the degree of design freedom for the speaker, and also to use an existing diaphragm or an existing magnetic circuit 3 to provide a speaker of various types of performance. In addition, a reduction in thickness of a speaker is achieved without constraints of the thickness of the diaphragm and the thickness of the voice coil.

The terms and description used herein are set forth by way of illustration only and are not meant as limitations. Those skilled in the art will recognize that numerous variations are possible within the spirit and scope of the invention as defined in the following claims.

What is claimed is:

1. A speaker, comprising:
a diaphragm having a dome formed in an outwardly convex shape and in its central portion and an edge formed around and integrally with the dome;
a coupling supporter fixed to a boundary portion of the diaphragm provided between the dome and the edge, and extending either inward or outward from the boundary portion in a radial direction of the diaphragm;
a voice coil fixed to a peripheral side of the coupling supporter; and
a magnetic circuit having a magnetic gap housing the voice coil.

2. A speaker according to claim 1, wherein the coupling supporter has a bent portion bending and extending in a vibrating direction of the voice coil.

3. A speaker according to claim 1, wherein the coupling supporter has a bent portion that bends the coupling supporter such that the peripheral side is located in a space within the dome of the outwardly convex shape.

4. A method for manufacturing a speaker comprising: a diaphragm having a dome formed in an outwardly convex shape and in its central portion and an edge formed around and integrally with the dome; a coupling supporter fixed to a boundary portion of the diaphragm provided between the dome and the edge and extending either inward or outward from the boundary portion in a radial direction of the diaphragm; a voice coil fixed to a peripheral side of the coupling supporter; and a magnetic circuit having a magnetic gap housing the voice coil, the method comprising the steps of:
attaching a centering jig having a positioning groove corresponding to the magnetic gap to a speaker frame;
inserting the voice coil in place in the positioning groove;
fixing the coupling supporter to the voice coil;
joining the boundary portion of the diaphragm and the coupling supporter together while an outer periphery of the diaphragm is attached to an inner periphery of the speaker frame;
removing the centering jig from the speaker frame; and
attaching the magnetic circuit to the speaker frame.
